(19) United States
(12) Patent Application Publication
(10) Pub. No.: US 2013/0143024 A1
(43) Pub. Date: Jun. 6, 2013

(54) Laminated Cloth

(71) Applicant: Chiem-Chung Hu, Tainan (TW)

(72) Inventor: Chiem-Chung Hu, Tainan (TW)

(21) Appl. No.: 13/309,608

(22) Filed: Dec. 2, 2011

(51) Int. Cl. B32B 5/00

(52) U.S. Cl. 428/221

(57) ABSTRACT

A laminated cloth includes a cloth layer having a first side and a second side opposite to the first side. A thermally insulating rubber sheet includes a first surface and a second surface opposite to the first surface. An adhesive layer is bonded between the second side of the cloth layer and the first surface of the thermally insulating rubber sheet. A cloth containing ceramic powders includes a first face and a second face opposite to the first face. A ceramic powders/adhesive layer is bonded between the second surface of the thermally insulating rubber sheet and the first face of the cloth containing ceramic powders.

### BACKGROUND OF THE INVENTION

The present invention relates to a laminated cloth and, more particularly, to a laminated cloth with heat accumulation and temperature maintaining effect for application in clothes for sports and workout.

Special materials can be added into cloths for making clothes so that the clothes can exhibit desired functions from the special materials. As an example, ceramic powders can be added into a cloth for making clothes. Since, the ceramic powders can absorb the heat of the human body and emit far-infrared rays to improve blood circulation, a warm keeping effect can be provided to the body of a wearer wearing the clothes made from the cloth containing the ceramic powders. However, the ceramic powders are liable to fall off after washing, causing degrading of the warm keeping effect.

Laminated cloths have been developed and include several layers of different materials for different demands. As an example, ceramic powders are glued with an adhesive to form a ceramic powders/adhesive layer, and cloths are bonded to two opposite sides of the ceramic powders/adhesive layer to form a laminated cloth that can be used to produce warm keeping clothes. The ceramic powders are bonded together by the adhesive and, thus, less likely to fall off from the clothes even though the clothes are washed. However, the heat desired for improving the blood circulation of the wearer is apt to dissipate, because the laminated cloth can not provide heat insulating effect. Thus, the body heat of the wearer is liable to dissipate, and the warm keeping effect is reduced.

Thus, a need exists for a novel laminated cloth with heat accumulation and temperature maintaining effect.

### BRIEF SUMMARY OF THE INVENTION

A laminated cloth according to the present invention includes a cloth layer having a first side and a second side opposite to the first side. A thermally insulating rubber sheet includes a first surface and a second surface opposite to the first surface. An adhesive layer is bonded between the second side of the cloth layer and the first surface of the thermally insulating rubber sheet. A cloth containing ceramic powders includes a first face and a second face opposite to the first face. A ceramic powders/adhesive layer is bonded between the second surface of the thermally insulating rubber sheet and the first face of the cloth containing ceramic powders.

The thermally insulating rubber sheet can be styrene butadiene rubber or a thermoplastic elastomer. In an example, the ceramic powders/adhesive layer includes 2-15 wt % of ceramic powders and 85-98 wt % of liquid glue.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a schematic cross sectional view illustrating production of a laminated cloth according to the present invention.

FIG. 2 shows a partial, cross sectional view of the laminated cloth according to the present invention.

FIG. 3 shows a perspective view of a pair of shorts made from the laminated cloth according to the present invention.

FIG. 4 shows a perspective view of a pair of sports shorts made from the laminated cloth according to the present invention.

FIG. 5 shows a perspective view of a pair of sports pants made from the laminated cloth according to the present invention.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “upper”, “lower”, “end”, “portion”, “side”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE INVENTION

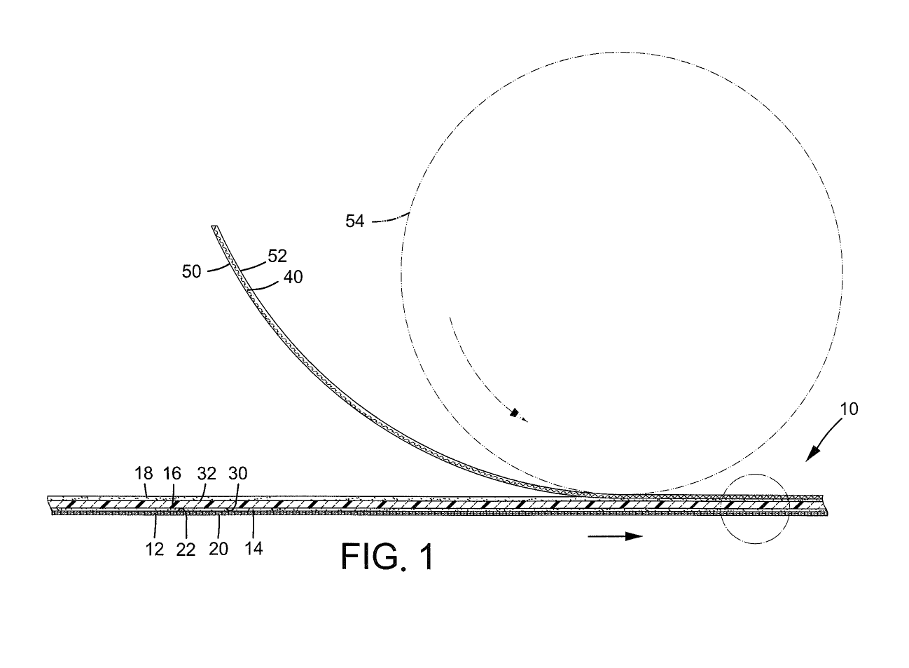

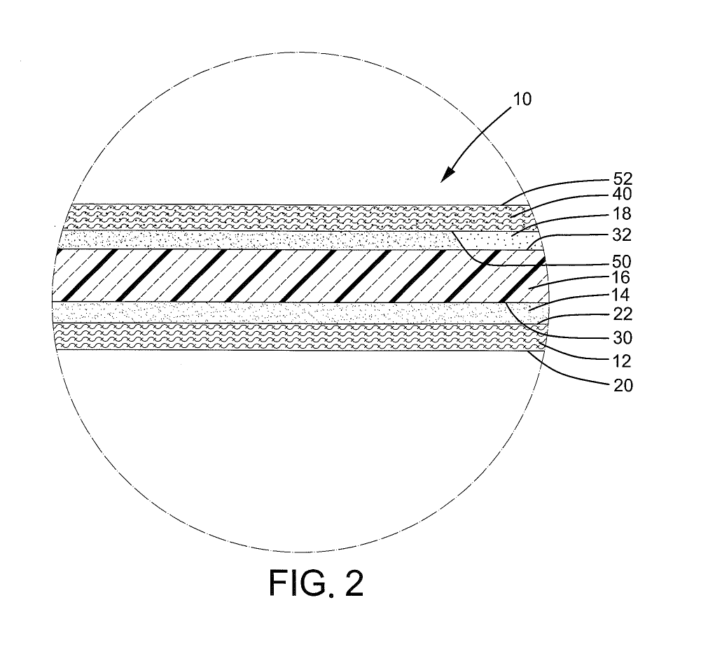

A laminated cloth according to the present invention is shown in FIGS. 1 and 2 of the drawings and generally designated 10. Laminated cloth 10 includes a cloth layer 12, an adhesive layer 14, a thermally insulating rubber sheet 16, a ceramic powders/adhesive layer 18, and a cloth 40 containing ceramic powders. Laminated cloth 10 can be used to produce sports clothes with enhanced effect in accumulation of heat and maintenance of temperature.

Cloth layer 12 can be woven fabric or nonwoven. Cloth layer 12 includes a first side 20 and a second side 22 opposite to first side 20.

Thermally insulating rubber sheet 16 includes a first surface 30 and a second surface 32 opposite to first surface 30. Thermally insulating rubber sheet 16 can be styrene butadiene rubber (SBR) or a thermoplastic elastomer. The styrene butadiene rubber is a copolymer of styrene and butadiene and includes properties of excellent insulation to heat and, thus, provides warm keeping effect.

Adhesive layer 14 is a layer of a plastic adhesive or a resin of any desired type. Adhesive layer 14 is sticky when in a liquid state. Adhesive layer 14 is bonded between second side 22 of cloth layer 12 and first surface 30 of thermally insulating rubber sheet 16.

Cloth 40 containing ceramic powders is obtained by submerging a cloth in a liquid containing ceramic powders. The cloth can be firstly dyed to have a desired color, such as yellow, red, green, etc. After dyeing, the cloth is submerged in the liquid containing ceramic powders and then dried to make the ceramic powders to adhere to the cloth, forming cloth 40 containing ceramic powders. Cloth 40 containing ceramic powders includes a first face 50 and a second face 52 opposite to first face 50.

Ceramic powders/adhesive layer 18 is obtained by mixing sticky liquid glue with ceramic powders or bio-ceramic powders. Ceramic powders/adhesive layer 18 includes 2-15 wt % of ceramic powders and 85-98 wt % of liquid glue. Ceramic powders/adhesive layer 18 is bonded between second surface 32 of thermally insulating rubber sheet 16 and first face 50 of cloth 40 containing ceramic powders.

In production of laminated cloth 10, first surface 30 of thermally insulating rubber sheet 16 is bonded by adhesive layer 14 to second side 22 of cloth layer 12 to form a cloth body. Ceramic powders/adhesive layer 18 is then applied to second surface 32 of thermally insulating rubber sheet 16 of the cloth body that is being conveyed. Next, first face 50 of cloth 40 containing ceramic powders is bonded by ceramic powders/adhesive layer 18 to second surface 32 of thermally insulating rubber sheet 16 by a heating roller 54 through pressing (see FIG. 1). Thus, ceramic powders/adhesive layer 18 is bonded between second surface 32 of thermally insulating rubber sheet 16 and first face 50 of cloth 40 containing ceramic powders.

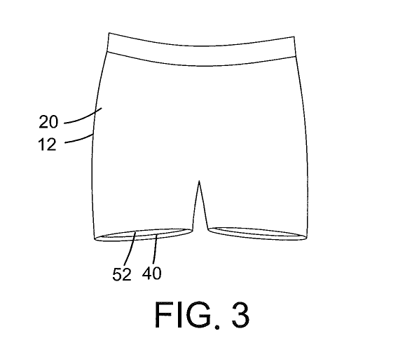

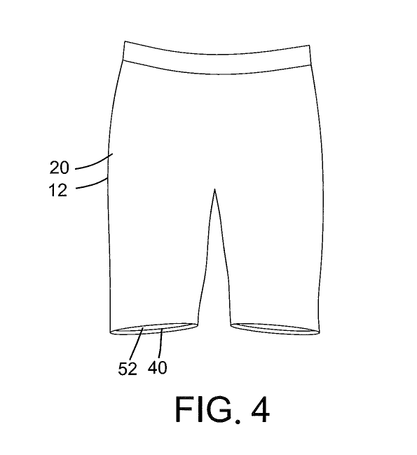

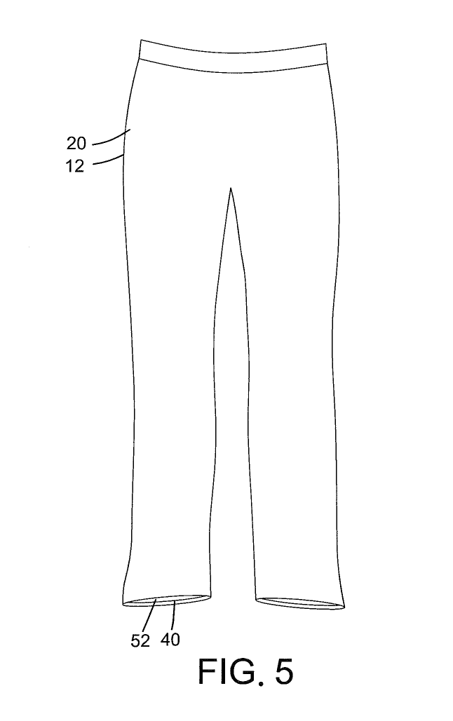

Laminated cloth 10 can be used to produce various sports clothes, such as shorts (FIG. 3), sports shorts (FIG. 4), and sports pants (FIG. 5) having various sizes and shapes for various customers. Second face 52 of cloth 40 containing ceramic powders forms the inner side of the sport clothes made from laminated cloth 10. When a wearer wearing the sport clothes made from laminated cloth 10, second face 52 of cloth 40 containing ceramic powders comes in contact with the skin of the wearer, providing comfortable touch. Furthermore, ceramic powders/adhesive layer 18 is adjacent to the skin of the wearer. The ceramic powders in cloth 40 containing ceramic powders and in ceramic powders/adhesive layer 18 can absorb the body heat of the wearer and emit far-infrared rays to improve the blood circulation of the body of the wearer. Thus, the body of the wearer gives off heat rapidly. When the body of the wearer moves and gives off heat and sweats, a portion of the sweat flows out of the pores of the body to carry away a portion of the heat. The body heat at the body portion wearing the sports clothes is insulated by thermally insulating rubber sheet 16 such that the heat energy can not easily dissipate from the body portion wearing the sports clothes that fits the wearer. Furthermore, thermally insulating rubber sheet 16 possesses excellent waterproof effect and excellent thermally insulating effect and, thus, can cause the body portion wearing the sports clothes to rapidly give off heat, accumulate heat, and maintain the temperature. Thus, the body of the wearer can rapidly sweat and consume considerable body fats.

Laminated cloth 10 provides comfortable touch to the body portion wearing the sports clothes made from laminated cloth 10 by providing cloth 40 containing ceramic powders, providing wearing comfort. Furthermore, even if the ceramic powders in cloth 40 fall off during washing, the ceramic powders in ceramic powders/adhesive layer 18 adjacent to the skin of the body of the wearer can provide the heat accumulation effect while thermally insulating rubber sheet 16 provides heat insulating effect. Thus, the accumulated heat is less likely to dissipate.

Laminated cloth 10 according to the present invention is different from conventional laminated clothes in the arrangement of the layers thereof. Furthermore, the ceramic powders (in cloth 40 and ceramic powders/adhesive layer 18) and thermally insulating rubber sheet 16 provide synergistic results in insulation of the heat, providing better effect in workout and loosing weight.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A laminated cloth comprising:
a cloth layer including a first side and a second side opposite to the first side;
a thermally insulating rubber sheet including a first surface and a second surface opposite to the first surface;
an adhesive layer bonded between the second side of the cloth layer and the first surface of the thermally insulating rubber sheet;
a cloth containing ceramic powders and including a first face and a second face opposite to the first face; and
a ceramic powders/adhesive layer bonded between the second surface of the thermally insulating rubber sheet and the first face of the cloth containing ceramic powders.

2. The laminated cloth as claimed in claim 1, with the thermally insulating rubber sheet being styrene butadiene rubber.

3. The laminated cloth as claimed in claim 2, with the ceramic powders/adhesive layer including 2-15 wt % of ceramic powders and 85-98 wt % of liquid glue.

4. The laminated cloth as claimed in claim 1, with the thermally insulating rubber sheet being a thermoplastic elastomer.
